(19) United States
(12) Patent Application Publication
(10) Pub. No.: US 2026/0169936 A1
(43) Pub. Date: Jun. 18, 2026

(54) SHARED MEMORY TO EXCHANGE DATA BETWEEN APPLICATIONS

(71) Applicant: TOSHIBA GLOBAL COMMERCE SOLUTIONS, INC., Durham, NC (US)

(72) Inventors: Andrei KHAITAS, McKinney, TX (US); Leonid GONCHAR, Wroclaw (PL); Serhii NOVYK, Kharkiv (UA); Illia IORIN, Wroclaw (PL); Serhii MAKSYMENKO, Kharkiv (UA)

(21) Appl. No.: 18/981,029

(22) Filed: Dec. 13, 2024

(51) Int. Cl. G06F 13/16; G06F 9/38

(52) U.S. Cl. CPC G06F 13/1663; G06F 9/3867; G06F 13/1673

(57) ABSTRACT

The embodiments herein describe a platform abstraction layer (PAL) for an edge device (e.g., a camera) that enables services developed in different programming languages to be executed as a pipeline on the edge device. For example, the services may be deployed in separate containers developed using different programming languages. In one embodiment, the stages in the pipeline can use buffers in a shared memory to share data. The data can include unique IDs (e.g., frame IDs) to search an index array for the shared memory to identify the buffer containing the processed data. In this manner, the shared memory supports random access.

### BACKGROUND

Performing compute intensive operations in edge devices, which may have limited compute resources, can be a difficult challenge. Not only do edge devices have limited resources (compared to compute systems in data centers or cloud computing environments) but they can also have different hardware systems. Thus, a process performed on one edge device may need a different deployment than another edge device because of differences in hardware in the edge devices. A software developer would need to understand the nuances of the underlying hardware in the edge device in order to identify the optimal deployment.

### BRIEF DESCRIPTION OF THE DRAWINGS

FIG. 1 illustrates a platform abstraction layer for an edge device, according to embodiments.

FIG. 2 illustrates a deployment of a pipeline in a platform abstraction layer of an edge device, according to embodiments.

FIG. 3 illustrates a shared memory for a pipeline deployment in an edge device, according to embodiments.

FIG. 4 is a flowchart for indexing new frames in a shared memory, according to embodiments.

FIG. 5 illustrates segments in a shared memory, according to embodiments.

FIG. 6 is a flowchart for sharing data between services using a shared memory, according to embodiments.

FIG. 7 is a flowchart for establishing a platform abstraction layer, according to embodiments.

### DETAILED DESCRIPTION

The embodiments herein describe a platform abstraction layer (PAL) for an edge device (e.g., a camera) that enables microservices developed in different programming languages to be executed as a pipeline on the edge device. For example, the microservices may be deployed in separate containers developed using Java, Python, C++, etc. Developing microservices using different programming languages is often the case for pipeline processes that perform different functions such as image processing, image detection (e.g., using an artificial intelligence (AI) or machine learning (ML) model), video recording, simulations, and the like. Typically, sharing data between different stages in a pipeline (e.g., the different microservices) which are developed using different programming languages requires copying data into different buffers for each containers. As an example, video processing which requires hardware acceleration is often performed in C++, but most ML applications which implement business logic are written on Python. At the same time applications which communicate with the cloud and need access to the video are normally written in Java. Sharing data between these different applications (which use different programming languages) relies on copying output data from one application into a buffer for another application. These data copies add latency and use processing power.

In one embodiment, the stages in the pipeline can use a shared memory to share data. One microservice (e.g., a Java microservice) can process data and then store the data in a buffer (or segment) in the shared memory. That microservice can then inform a downstream microservice (e.g., a Python microservice) that the processed data is ready for its consumption. The downstream microservice can then use unique IDs (e.g., frame IDs) to search an index array for the shared memory to identify the segment containing the processed data. In this manner, the shared memory supports random access, unlike other shared memory implementations that support only sequential access of data. Moreover, the microservices can share data without the data having to be moved (copied) between different buffers. Using shared memory with reallocation frames without copy decreases load on the system bus and dramatically optimizes memory usage, which is a large advantage when using embedded systems.

In one embodiment, the PAL can make the microservices hardware agnostic where the microservices can execute on different hardware platforms. For example, rather than the microservices having to run on the same hardware platform and use the same programming language, different microservices can be used and executed on the most efficient hardware system. For instance, an inference microservice (which executes an AI model) can be programmed in Python and execute on an AI accelerator in the edge device while an image encoding microservice can be programmed in C++ and execute on the central processing unit (CPU). Advantageously, these microservices can be part of the same video processing pipeline in the edge device but yet execute on different hardware systems within the edge device and communicate using the shared memory. This means the microservices can be programmed in different languages and execute on specialized hardware within the edge device.

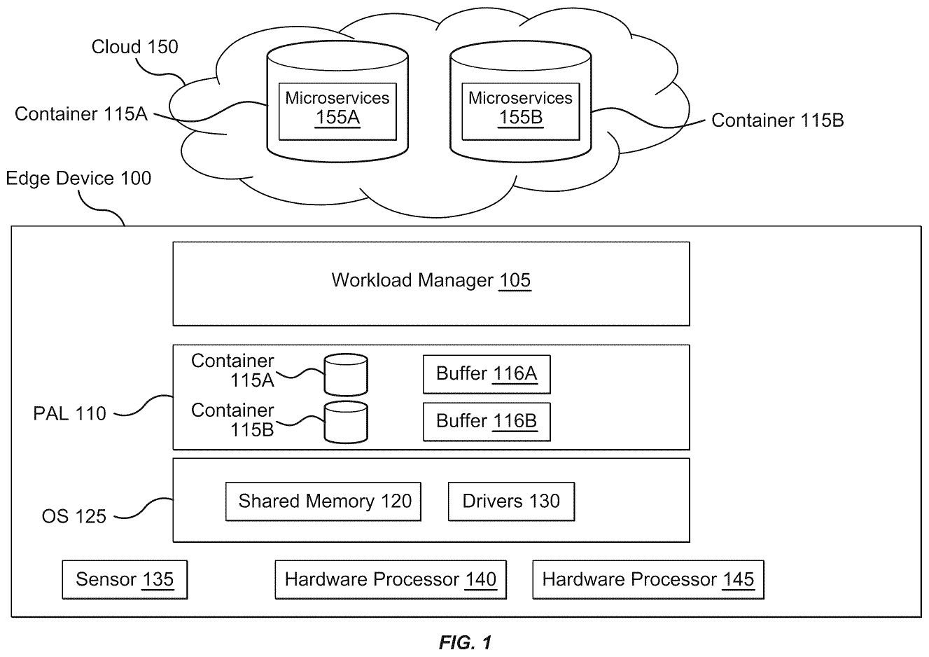

FIG. 1 illustrates a PAL 110 for an edge device 110, according to embodiments. The edge device 110 includes a sensor 135 for receiving input from the physical environment. For example, the edge device 110 may be a camera (where the sensor 135 is an image sensor), a point of sale (POS) device or system (where the sensor 135 could be one or more cameras, scales, pressure sensor, etc.), a smart thermostat (where the sensor 135 is a temperature sensor), and the like. In one embodiment, the edge device can be any network connected device that includes at least one sensor 135 for recording information about the physical environment. The edge device 110 may be an Internet of Things (IoT) device (e.g., an Ethernet connected camera).

Instead of offloading the processing of the information recorded by the sensor 135 to the cloud 150, the embodiments herein can use the PAL 110 to process the sensor data locally using hardware processors 140, 145 on the edge device 100. In this embodiment, the edge device 100 includes two different types of hardware processors 140, 145, but in other embodiments can have only one type of hardware processor (e.g., a CPU), or more than two types of hardware processors 140, 145. The advantage of having a heterogeneous processing environment in the edge device 100 is that different tasks or stages of a pipeline used to process the sensor data may be more efficient to execute on one type of hardware processor than the other. For instance, inference processes which execute a ML model may operate more efficiently (e.g., use less time and/or less power) on an AI accelerator (e.g., a neural network (NN) processor or a neural processing unit (NPU)). In contrast, video encoding/decoding and video preprocessing may execute more efficiently in a general processor (e.g., a CPU).

The PAL 110 enables microservices 155, which can perform specialized tasks (and are programmed using different programming languages), to execute on the same, or different, hardware processors in the edge device 100. In one embodiment, the microservices 155 are independent services that are separately deployable and that communicate over application programming interfaces (APIs). While this disclosure primarily describes microservices, this is just one example. The containers 115 can include software code for performing any service.

Because the microservices 155 are developed using different programming languages, the PAL 110 provides access to shared memory 120 (which is illustrated as native memory in the operating system (OS) 125) that the microservices 155 can use to share data.

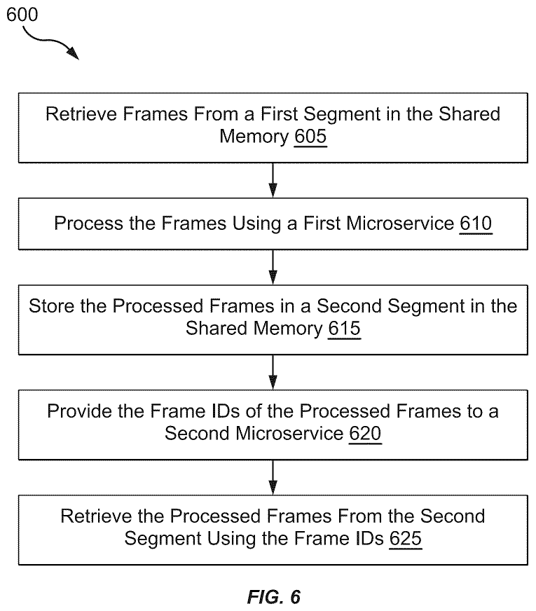

As discussed in more detail below in FIG. 6, a first microservice 155A can retrieve data from the shared memory 120, process the data, and store the processed data into a first segment in the shared memory 120. A second microservice 155B can then retrieve the data from the first segment and process the data. This avoids having to copy the processed data generated by the first microservice 115A into a separate buffer that is accessible to the second microservice 155B.

To configure the PAL 110, the edge device 100 includes a workload manager 105 that retrieves the containers 115 from the cloud 150 containing the microservices 155 used to establish a pipeline in the PAL 110. That is, the cloud 150 can store various microservices 155 that are stored in containers 115. In one embodiment, the containers 115 are an abstraction at the application layer that packages code and dependencies together. Multiple containers 115 can run on the same machine and share the OS kernel with other containers, each running as isolated processes in user space. In one embodiment, the containers 115 can enable the microservices 155 to run on any OS. The containers 115 can have their own file system, dependency structure, processes, and network capabilities. In one embodiment, the containers 115 have microservices 155 that are programmed in the same programming language. For example, a container 115 may not include microservices 155 developed using different programming languages.

The workload manager 105 can identify the microservices that perform different stages of a desired pipeline, retrieve the containers 115 containing those microservices from the cloud 150, and place those containers 115 in the PAL 110.

The workload manager 105 can also establish buffers 116 in the PAL which are segments of memory in the shared memory 120 that enable the microservices 155 in the containers 115 to communicate and share data (without additional copying). That is, the buffers 116 in the PAL 110 are abstractions of different segments in the shared memory 120. As such, the buffers 116 may be accessible to each container 115, but the containers 115 may access only the subset of buffers 116 that are used for performing their respective microservices 155.

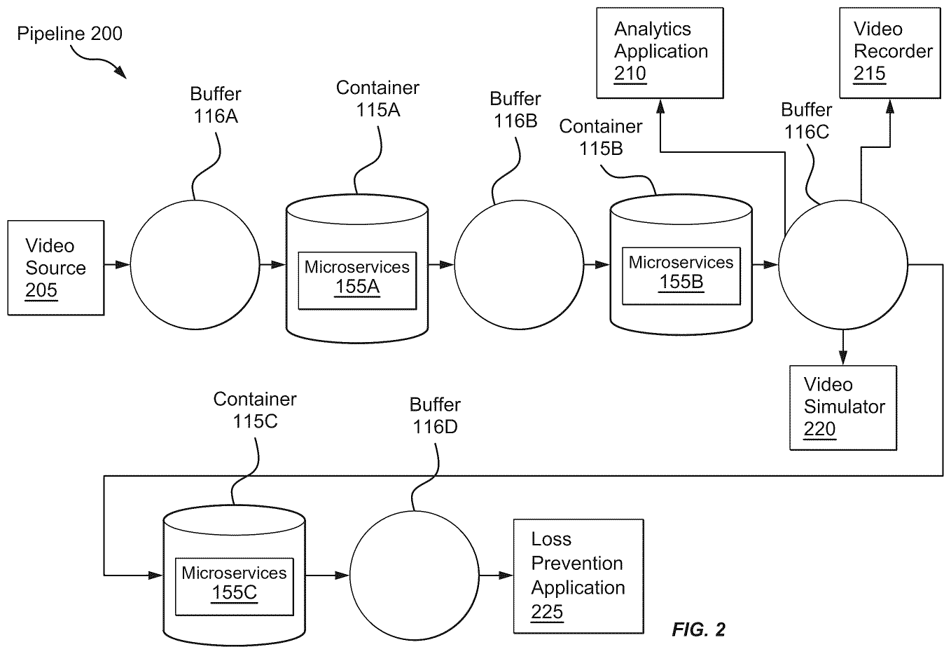

In one embodiment, the containers 115/microservices 155 and the buffers 116 in the PAL 110 are arranged to form a pipeline, where the buffers 116 (e.g., segments in the shared memory 120) serve as intermediaries between the containers. One example pipeline is illustrated in FIG. 2 below. The pipeline can receive the data generated by the sensor 135 as an input and process that data at various stages in the pipeline (implemented using the various containers 115) where the output of one container 115 is stored in a buffer 116 which is then accessible to another container 115 to retrieve the data as its input. In some scenarios, multiple containers 115 may retrieve data (i.e., read data) from the same buffer 116, while just one container (or input source) may have permission to write data into a particular buffer 116.

In addition to the native OS shared memory 120, the OS 125 also includes drivers 130 which enable the OS 125 to control the tasks performed by the hardware processors 140, 145. That way, the OS 125 can execute the containers 115 on a particular hardware processor—e.g., execute an inference microservice on an AI accelerator but execute a video encoding microservice on a CPU.

Moreover, in one embodiment, the PAL 110 enables the pipelined processes to be device agnostic. That is, regardless whether the edge device 100 has only one type of hardware processor, or multiple types of hardware processors, different types of containers 115/microservices 155 can be pipelined to perform the desired tasks. As such, the PAL 110 can make the embodiments described herein portable among multiple different hardware platforms. That is, implementing the buffers 116 in the shared memory 120 means different types of microservices 155 can be used and execute on whatever hardware processors are available in the edge device 100. The PAL 110 provides hardware abstraction for data processing (e.g., video processing and inference features).

The PAL 110 also gives the developer the opportunity to select microservices 155 that are best suited for the hardware processors in the particular edge device 100. For example, if the edge device 100 has a NN processor instead of a NPU, the developer may select a different type of inference microservice (e.g., which may be programmed using different programming languages). As another example, if the edge device 100 only has a CPU, the developer may select an inference microservice that is optimized for execution on a CPU rather than a microservice optimized for an AI accelerator. The PAL 110 gives the developer the ability to mix and match different microservices 155 (e.g., developed using different programming languages) and still use them in the same pipeline.

FIG. 2 illustrates a deployment of a pipeline 200 in a PAL of an edge device, according to embodiments. For example, the system illustrated in FIG. 1 can be used to connect the containers 115, buffers 116, applications, etc. into the pipeline 200 in a PAL of an edge device.

The pipeline 200 processes video frames captured by a camera, which are provided by a video source 205. However, this is just one example of a suitable pipeline 200. The embodiments herein can be used for processing other types of sensor data such as temperature measurements, pressure measurements, audio recordings, and the like. In general, the pipeline can process any data captured by a sensor on an edge device.

The video source 205 provides the frames to a first buffer 116A, which are then retrieved by the container 115A and processed by the corresponding microservices 155A. For example, the container 115A and microservices 155A may perform pre-processing on the frames.

The container 115A then stores the resulting frames in the buffer 116B. The container 115B can then retrieve those frames from the buffer 116B and execute microservices 115B (e.g., an encoder operation). For example, the container 115B may generate an encoder stream of frames which are stored in the buffer 116C. The details of how the containers 115 can pass data to each other is described in more detail in FIG. 6.

In addition to being accessible by the containers 115, the buffers 116 can be accessible to applications, such as an analytics application 210, a video recorder 215 application, a video simulator 220 application, and the like. These are just some of the different applications that can execute on the edge device and access the frames being generated by the pipeline 200. Moreover, in this example, these applications can read the frames from the same buffer 116C. However, these applications may store the processed data in other memory (e.g., user memory space) rather than in buffers in the pipeline 200. As mentioned above, the buffers 116 can be part of shared memory, which can be native OS memory.

The container 115C retrieves the frames from the buffer 116C and processes them using the microservices 155C. The resulting frames are stored in the buffer 116D. For example, the microservices 155C may perform a decoding operation on the encoded frames stored in the buffer 116C, where the decoded frames are stored in the buffer 116D.

A loss prevention application 225 can then access the buffer 116D to perform further processing on the decoded frames. For example, the analytics application 210, video recorder 215, loss prevention application 225, and video simulator 220 may be part of a POS system (e.g., an Ethernet coupled camera for a POS system).

While shown as separate buffers 116A-D, in one embodiment this is an abstraction where the buffers 116 are actually implemented in different segments of shared memory (e.g., the native OS shared memory 120 in FIG. 1). Thus, the buffers 116 may be accessible to each container 115, but the containers 115 may access only the buffers 116 (i.e., segments of the shared memory) that contain information they use to execute their corresponding microservices 115. For example, the container 115B may be able to access buffer 116A and 116D, but it does not access those buffers since they do not store frames it uses when executing the microservices 155B.

Because the buffers 116 are segments in the shared memory, the frames do not have to be copied when being “transferred” from one container 115 to the next in the pipeline. Instead, the upstream container can store the processed frames in one buffer and the downstream container can retrieve the frames from that same buffer. This avoids having to copy the frames to individual buffers of the containers 115.

Moreover, the containers 115 may be executed by different types of hardware processors in the edge device (e.g., the hardware processors 140 and 145 in FIG. 1). For example, the containers 115A and 115B may be executed by a general purpose processor (e.g., a CPU) in the edge device while the container 115C is executed in a hardware accelerator. The microservices in the containers 115A and 115B may be programmed in a different programming language than the microservices in the container 115C. These containers 115 can nonetheless be in the same pipeline 200 and communicate using the buffers 116 (e.g., the shared memory).

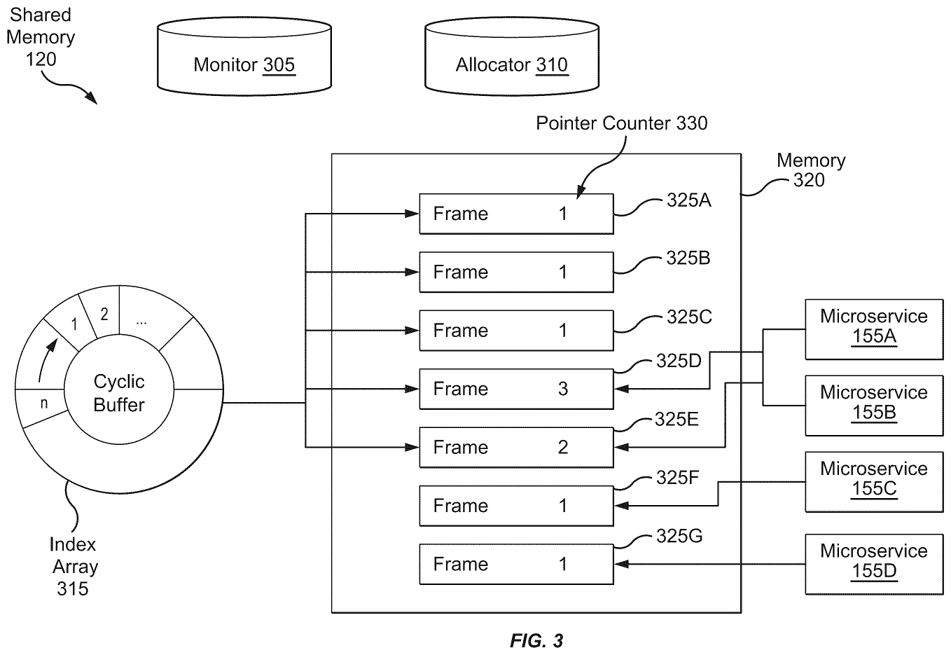

FIG. 3 illustrates a shared memory 120 for a pipeline deployment in an edge device, according to embodiments. The shared memory 120 includes a monitor 305, an allocator 310, memory 320 (e.g., volatile memory elements, non-volatile memory elements, or combinations thereof), and an index array 315.

The monitor 305 can monitor the memory 320 (e. g,. the maximum depth size) to determine if the memory 320 is too large or too small. The monitor 305 can also determine if frames are being removed too soon (or staying too long) in the memory 320. In one embodiment, the edge device may run tests to see the optimal size/depth of the memory 320 in order to execute a particular pipeline. In one embodiment, the monitor 305 can dynamically adjust the depth of the memory 320 in response to the memory access patterns of the microservices 155.

The allocator 310 can allocate entries in the memory 320 for new frames (e.g., new video frames generated by the video source 205 in FIG. 2). The allocator 310 can track which entries have valid frames (e.g., frames that are still indexed by the index array 315 or used by one of the microservices 155). The allocator 310 can also track invalid entries in the memory 320 which can be overwritten when new frames are received.

The index array 315 stores pointers to the frames 325 in the memory 320. To enable random access, when indexing new frames in the memory 320, the allocator 310 (or the video source) can assign frame IDs to the frames 325. The index array 315 can link these frames IDs to memory locations/pointers. That way, a microservice 155 can use a frame ID to index into the index array 315 and identify a memory pointer in the array 315 that points to the location where the corresponding frame is stored in the memory 320.

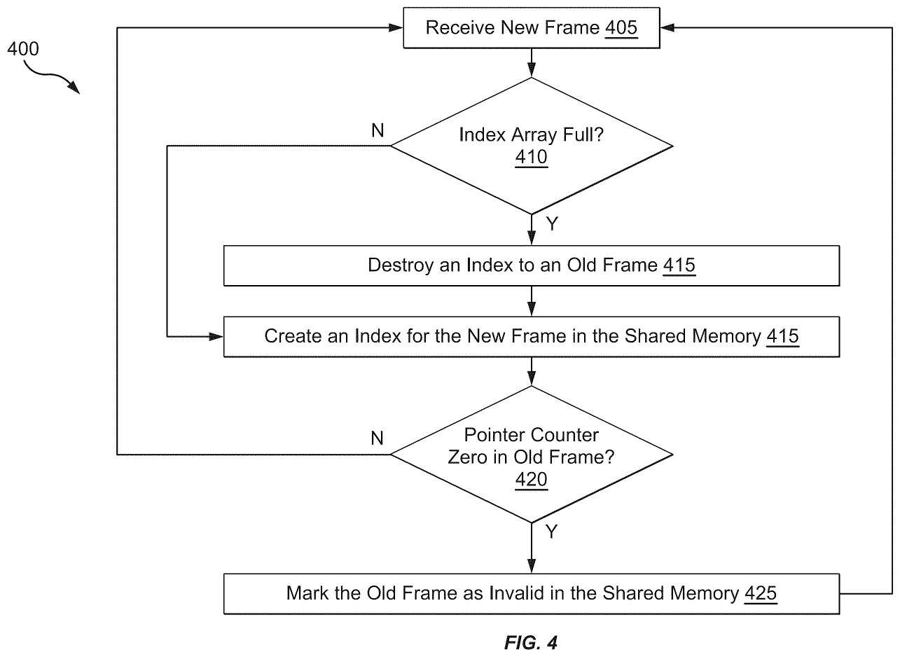

In one embodiment, the index array 315 may be unable to store indices for every memory location in the memory 320. Put differently, the memory 320 may have more entries than the array 315 can index. As more frames 325 are received from the video source, the index array 315 may continually destroy indices for the older frames (assuming its capacity has been met) so it can index the new frames. In this example, the index array 315 has indices (pointers) to frame 325A-325E in the memory 320 (but not to the last two frames 325F and 325G). Assuming five is the maximum number of frames the array 315 can index, when a new frame arrives the index to the oldest frame is destroyed and replaced with an index to the new frame. Adding new frames is discussed in more detail in FIG. 4.

In this embodiment, the index array 315 is implemented using cyclic buffer, but this is just one example of a suitable array 315.

Like the index array 315, the microservices 155 can have pointers to the frames 325, indicating they are using those frames. In this embodiment, the entries for the frames 325 store a pointer counter 330 indicating the number of entities that have (or are using) pointers to the frame 325. For instance, the frame 325A has a pointer counter value of 1 since only the index array 315 has a pointer to that frame. In contrast, frame 325D is pointed to by the index array 315, microservice 155A and microservice 155B, and thus, has a pointer counter value of 3.

Also, because the index array 315 may not be allocated sufficient memory to index every frame 325 in the memory 320, the index array 315 does not have pointers to the frames 325F and 325G, but these frames 325F, 325G are pointed to by the microservice 155C and microservice 155D, respectively. Once these microservices are done with the frames 325F and 325G, the pointer counter 330 is decremented to zero which indicates to the allocator 310 that these frames are no longer being used. The allocator 310 can then invalidate those entries so that new frames can be written into those memory locations. In this manner, the frames can continue to be stored in the memory 320 so long as they are being pointed to by at least one microservice 155, even if those frames are no longer being indexed by the index array 315. Thus, another microservice 155 would be unable to use the index array 315 to identify the frames 325F and 325G, and would have to rely on the microservices 155C and 115D to provide them with the pointer to those frames 325F and 325G.

If a microservice 155 provides the index array 315 with a frame ID for a frame that is no longer being indexed by the array 315, then it will result in an invalid lookup. For example, the index array 315 may index the frames captured in the last nine seconds but a microservice 155 may send a request to access a frame captured 9.5 seconds ago. Although this lookup may fail, the monitor 305 can detect this failure and decide to increase the size of index array 315 to maintain pointers/indices for frames for longer. Similarly, if the monitor 305 determines that the microservices 155 very rarely request frames that are older than seven seconds, it may reduce the size of the index array 315.

In one embodiment, the entries for the frames 325 also stores timestamps. The timestamps can serve as the frame ID (or be used in addition to unique frame IDs).

FIG. 4 is a flowchart of a method 400 for indexing new frames in a shared memory, according to embodiments. For example, the method 400 can be used to store new frames received from a video source into the shared memory illustrated in FIG. 3.

At block 405, the shared memory receives a new frame from the video source. The allocator may assign a unique frame ID to the new frame if one was not assigned to the frame by the video source. In another embodiment, a timestamp could be used as the frame ID.

At block 410, the shared memory determines if the index array (e.g., a cyclic buffer) is full. If so, the method 400 proceeds to block 415 where the index array destroys a pointer to an old frame. For example, the index array may remove the pointer to the oldest frame the array indexes in the shared memory.

At block 415, the index array creates an index for the new frame in the shared memory. In one embodiment, the index stores a frame ID for the frame as well as the memory location of the frame in the memory. That way, a microservice (or other application that is part of the pipeline) can use the frame ID to retrieve the pointer from the index array and access (or read) the frame.

At block 420, the allocator determines whether the pointer counter for the old frame is zero. That is, when the index array removes the index for an old frame (to make an index for a new frame), the allocator evaluates the pointer counter of that frame to determine whether any other entity (e.g., a microservice or a software application) is using (or may use in the future) the frame. If the pointer counter is zero, this means no other entity wants to access the frame. In that case, the method 400 proceeds to block 425 where the allocator marks the old frame as invalid in the shared memory. This means that the memory location of the old frame is now free and the allocator can use that location to overwrite the old frame and store a new frame.

However, if the pointer counter is not zero, the method 400 instead returns to block 405 to wait for a new frame. In that case, although the frame in no longer indexed by the index array of the shared memory, it is still a valid entry in the shared memory so it can continue to be accessed by another entity (e.g., a microservice or application) that already has a pointer to that memory location.

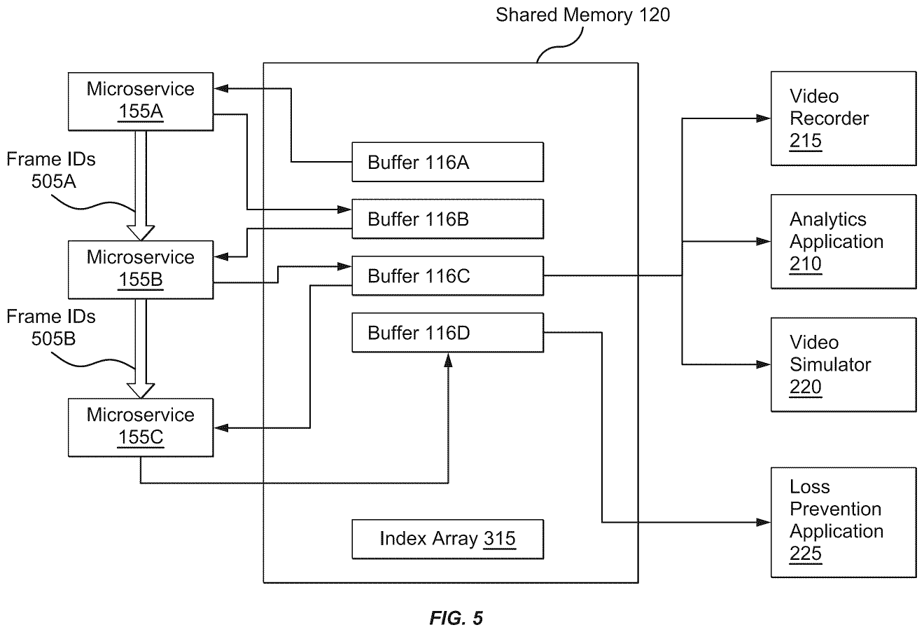

FIG. 5 illustrates buffers 116 in the shared memory 120, according to embodiments. In one embodiment, the buffers 116 can include a plurality of the frames 325 illustrated in FIG. 3. Moreover, the individual frames in the buffers 116 can be managed as discussed in FIGS. 3 and 4.

FIG. 5 illustrates the microservices 155 using the buffers 116 to transfer data according to the pipeline 200 shown in FIG. 2. As shown, the buffers 116 are separate segments in the shared memory 120. In one embodiment, the buffers 116 stop different types of data (e.g., encoded frames, decoded frames, pre-processed frames, etc.). In other words, the same types of data may be stored in the same buffers 116 in the shared memory 120, which can advantageously result in improved memory efficiency.

FIG. 6 is a flowchart of a method 600 for sharing data between services using a shared memory, according to embodiments. For ease of explanation, the method 600 is discussed in tandem with the shared memory 120 illustrated in FIG. 5.

At block 605, a microservice retrieves frames from a first segment (e.g., buffer) in the shared memory. For example, in FIG. 5 the microservice 115A reads frames from the buffer 116A.

At block 610, the microservice processes the frames. That is, the microservice 115A can process the frames retreived from the buffer 116A such as performing pre-processing, encoding, etc.

At block 615, the microservice stores the processed frames in a second segment in the shared memory. As shown in FIG. 5, the microservice 115A stores the resulting frames in the buffer 116B.

At block 620, the microservice provides the frame IDs of the processed frames to the second microservice. As shown in FIG. 5, the microservice 155A transmits the frame IDs 505A for the frames the microservice 155A stored in the buffer 116B to the microservice 155B.

At block 625, a second microservice retrieves the processed frames from the second segment using the frame IDs. In FIG. 5, the microservice 155B uses the frame IDs 505A to search the index array 315 to identify the pointers to the memory location of the frames in the buffer 116B and uses those pointers to retrieve the frames from buffer 116B.

The method 600 can then repeat as the pipeline continues so that the data is transferred between the microservices using the segments (or buffers) in the shared memory. Again referring to FIG. 5, the microservice 155B processes the frames, stores the resulting frames in the buffer 116C, and transmits the frame IDs 505B for the frames the microservice 155B stored in the buffer 116C to the microservice 155C. In response, the microservice 155C can use the frame IDs 505B to search the index array 315 to identify the pointers to the memory location of the frames in the buffer 116C and use those pointers to retrieve the frames from buffer 116C.

In this manner, the microservices 155 can exchange frames without those frames having to be copied into individual buffers for the microservices. That is, the buffers 116 can be shared by the microservices 155 without copying (i.e., zero-copy access to the buffered data) since they are segments within the shared memory 120.

As discussed above, timestamps can be used to search for the frames (e.g., used as the frame IDs). This may allow simulations to run faster (e.g., the video simulator 220 in FIG. 2). For example, having timestamps allows a simulator to run a simulation faster than real-time. Also, timestamps allow the data generated by multiple cameras to be correlated and compared to perform other tasks, such as loss prevention.

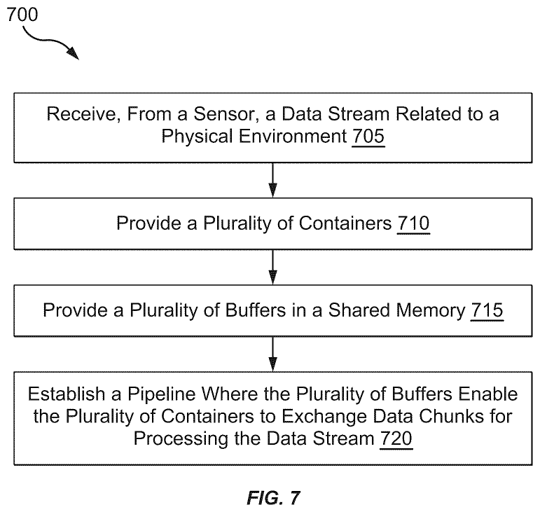

FIG. 7 is a flowchart of a method 700 for establishing a platform abstraction layer, according to embodiments. At block 705, the PAL receives, from a sensor, a data stream related to a physical environment. The sensor can be, for example, the sensor 135 described in FIG. 1 operating in an edge device 100.

At block 710, the PAL provides a plurality of containers. In one embodiment, a first container of the plurality of containers comprises a first service (e.g., a first microservice) written in a first programming language and a second container of the plurality of containers comprises a second service (e.g., a second microservice) written in a second, different programming language (e.g., Java, C++, Python, etc.). The services can be any of the microservices 155 discussed in FIG. 1 (or other types of services, which may not be microservices).

At block 715, the PAL provide a plurality of buffers in a shared memory. The shared memory can be any of the embodiments discussed above related to the shared memory 120 in FIGS. 1-6.

At block 720, the PAL establishes a pipeline where the plurality of buffers enable the plurality of containers to exchange data chunks for processing the data stream. One example of this pipeline was discussed in FIG. 2 which illustrates the pipeline 200 implemented in the PAL where the containers 115 are interconnected using the buffers 116.

In one embodiment, the data chunks (e.g., video frames) comprise unique IDs (e.g., frame IDs) so the shared memory supports random access by the plurality of containers.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure is not limited to the described embodiments. Instead, any combination of the features and elements, whether related to different embodiments or not, is contemplated to implement and practice contemplated embodiments. Furthermore, although embodiments disclosed herein may achieve advantages over other possible solutions or over the prior art, whether or not an advantage is achieved by a given embodiment is not limiting of the scope of the present disclosure. Thus, the aspects, features, embodiments, and advantages discussed herein are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

Aspects of the described embodiments may take the form of an entirely hardware embodiment, an entirely software embodiment (including firmware, resident software, micro-code, etc.) or an embodiment combining software and hardware aspects that may generally be referred to herein as a “circuit,” “module” or “system.”

One or more of the described embodiments may be a system, a method, and/or a computer program product. The computer program product may include a computer readable storage medium (or media) having computer readable program instructions thereon for causing a processor to carry out aspects of the embodiments.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the described embodiments may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the described embodiments.

Aspects of the described embodiments are described herein with reference to flowchart illustrations and/or block diagrams of methods, apparatus (systems), and computer program products according to embodiments. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a described manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing is directed to one or more embodiments, other and further embodiments may be devised without departing from the basic scope thereof, and the scope thereof is determined by the claims that follow.

What is claimed is:

1. A device comprising:
a sensor configured to generate a data stream related to a physical environment;
one or more hardware processors;
a shared memory; and
platform abstraction layer (PAL) comprising:
a plurality of containers, wherein a first container of the plurality of containers comprises a first service written in a first programming language and a second container of the plurality of containers comprises a second service written in a second, different programming language, and
a plurality of buffers in the shared memory, wherein the plurality of buffers enable the plurality of containers to exchange data chunks in order to form a pipeline for processing the data stream,
wherein the data chunks comprise unique IDs so the shared memory supports random access by the plurality of containers.

2. The device of claim 1, wherein the plurality of containers have zero-copy access to the plurality of buffers where the first container stores processed data chunks in a first buffer of the plurality buffers which can be retrieved by the second container from the first buffer without copying the processed data chunks into a separate buffer.

3. The device of claim 2, wherein the first container is configured to, after storing the processed data chunks in the first buffer, transmit a set of unique IDs corresponding to the processed data chunks to the second container,
wherein the second container is configured to:
use an index array for the shared memory to identify pointers to the processed data chunks in the first buffer using the set of unique IDs; and
retrieve the processed data chunks from the first buffer using the pointers.

4. The device of claim 3, wherein the index array is a cyclic buffer.

5. The device of claim 1, wherein the device is a network connected edge device configured to record information about the physical environment using the data stream.

6. The device of claim 5, wherein the edge device is a camera, wherein the sensor is configured to capture images of the physical environment and the data stream is a stream of video frames.

7. The device of claim 6, wherein the first service performs at least one of an encoding or decoding process on the stream of video frames and the second service performs an inference process corresponding to an artificial intelligence (AI) or machine learning (ML) model on the stream of video frames.

8. The device of claim 7, wherein the one or more hardware processors comprises a first hardware processor and an AI accelerator, wherein the first hardware processor is configured to execute the first service and the AI accelerator is configured to execute the second service.

9. The method of claim 1, wherein the data chunks each comprises a pointer counter in the shared memory indicating a number of the plurality of containers with pointers to a respective data chunk.

10. The device of claim 9, wherein the shared memory further comprises an allocator configured to mark the respective data chunk as invalid in response to determining the pointer counter has a value of zero.

11. A computer-readable storage medium having computer-readable program code defining a platform abstraction layer (PAL), the computer-readable program code executable by one or more computer processors to perform operations, the operations comprising:
receiving, from a sensor, a data stream related to a physical environment;
providing a plurality of containers, wherein a first container of the plurality of containers comprises a first service written in a first programming language and a second container of the plurality of containers comprises a second service written in a second, different programming language;
providing a plurality of buffers in a shared memory; and
establishing a pipeline where the plurality of buffers enable the plurality of containers to exchange data chunks for processing the data stream,
wherein the data chunks comprise unique IDs so the shared memory supports random access by the plurality of containers.

12. The computer-readable storage medium of claim 11, wherein the plurality of containers have zero-copy access to the plurality of buffers where the first container stores processed data chunks in a first buffer of the plurality buffers which can be retrieved by the second container from the first buffer without copying the processed data chunks into a separate buffer.

13. The computer-readable storage medium of claim 12, wherein the first container is configured to, after storing the processed data chunks in the first buffer, transmit a set of unique IDs corresponding to the processed data chunks to the second container,
wherein the second container is configured to:
use an index array for the shared memory to identify pointers to the processed data chunks in the first buffer using the set of unique IDs; and
retrieve the processed data chunks from the first buffer using the pointers.

14. The computer-readable storage medium of claim 11, wherein the sensor is configured to capture images of the physical environment and the data stream is a stream of video frames.

15. The computer-readable storage medium of claim 14, wherein the first service performs at least one of an encoding or decoding process on the stream of video frames and the second service performs an inference process corresponding to an AI or ML model on the stream of video frames.

16. The computer-readable storage medium of claim 15, wherein the operation further comprises:
assigning the first service to execute on a first hardware processor in a device; and
assigning the second service to execute on an AI accelerator in the device.

17. The computer-readable storage medium of claim 11, wherein the data chunks each comprises a pointer counter in the shared memory indicating a number of the plurality of containers with pointers to a respective data chunk.

18. The computer-readable storage medium of claim 17, wherein the operation further comprises marking the respective data chunk as invalid in the shared memory in response to determining the pointer counter has a value of zero.

19. A method comprising:
receiving, from a sensor, a data stream related to a physical environment;
providing a plurality of containers, wherein a first container of the plurality of containers comprises a first service written in a first programming language and a second container of the plurality of containers comprises a second service written in a second, different programming language;
providing a plurality of buffers in a shared memory; and
establishing a pipeline where the plurality of buffers enable the plurality of containers to exchange data chunks for processing the data stream,
wherein the data chunks comprise unique IDs so the shared memory supports random access by the plurality of containers.

20. The method of claim 19, wherein the plurality of containers have zero-copy access to the plurality of buffers where the first container stores processed data chunks in a first buffer of the plurality buffers which can be retrieved by the second container from the first buffer without copying the processed data chunks into a separate buffer.
